(19) United States
(12) Patent Application Publication
(10) Pub. No.: US 2007/0231529 A1
(43) Pub. Date: Oct. 4, 2007

(54) Optical information recording medium suppressing sulfuration of silver

(75) Inventors: Eiji Kariyada, Tokyo (JP); Shuichi Ohkubo, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/723,829

(22) Filed: Mar. 22, 2007

(30) Foreign Application Priority Data
Mar. 23, 2006 (JP) 2006-081248
Oct. 17, 2006 (JP) 2006-282875
Oct. 17, 2006 (JP) 2006-282876

(51) Int. Cl. B32B 3/02

(52) U.S. Cl. 428/64.4

(57) ABSTRACT

A phase-change optical disk includes a recording film, a reflection film and a dielectric film including oxide of at least one element selected from a first group consisting of niobium and zinc as the principal ingredient thereof and oxide of at least one element selected from a second group consisting of aluminum, tantalum, silicon, cerium and hafnium. The composition ratio of the oxide of the at least one element selected from the second group in the dielectric film is between 10 mol % and 45 mol %. The oxide film prevents sulfuration of the recording film including Ag.

### BACKGROUND OF THE INVENTION

1. Field of the Invention

The present invention relates to an optical information recording medium suppressing sulfuration of silver (Ag). More particularly, the present invention relates to an optical information recording medium having a reflection film or a semi-transmissive film containing Ag.

2. Description of the Related Art

Optical information recording media including an optical disk are such that information is recorded and reproduced thereon by means of a laser beam. Information can be recorded on and reproduced from a recording film in the optical disk at a high speed because it is not necessary to bring a head into contact with the optical disk. Additionally, since the focal point of the laser beam is extremely reduced in size, it is possible to record a large volume of information on and reproduce from the optical disk. Thus, optical disks are used in a variety of fields as a large capacity memory device.

Optical disks are classified into three types including the read-only type where information can only be reproduced therefrom, the write-once type where information can be recorded thereon and reproduced therefrom only once, and the rewritable type where information can be recorded thereon and reproduced therefrom repeatedly. From a different viewpoint, optical disks are grouped as the phase-change type optical disks that utilize phase changes of the recording film and magneto-optical disks that utilize changes in the direction of magnetization of perpendicularly magnetized film. Of these, phase-change type optical disks are taking the main stream of rewritable optical disks because information can be recorded thereon without using an external magnetic field unlike the magneto-optical disks, and in addition information can be overwritten with ease.

Meanwhile, there is a strong demand for optical disks having a larger memory capacity. To realize large-capacity optical disks, it is preferable to use a laser beam having a shorter wavelength. Therefore, intensive research efforts are being paid on the optical disks adapted to use a laser beam of a wavelength of about 405 nm.

Phase-change type optical disks (referred to as phase-change optical disks hereinafter) are generally prepared by consecutively laying a dielectric film, a recording film, another dielectric film and a reflection film on a transparent substrate. A laser beam is generally incident onto the optical disk from the side of the transparent substrate to record information on and reproduce information from the recording film. A material containing silver (Ag) as the principal ingredient thereof is generally used for the reflection film. Ag is less costly as compared with other noble metal elements and exhibits a sufficient reflectivity with respect to a laser beam having a wavelength of about 405 nm so that it can boost the amplitude of signals. Additionally, Ag exhibits a higher thermal conductivity and hence is suitable for a high speed recording scheme. Generally, ZnS—SiO₂ is used for the dielectric films. ZnS—SiO₂ has a high refractive index and provides a higher deposition rate so that it is suited for mass production.

However, phase-change optical disks are accompanied by a problem in that the semi-transmissive film or the reflection film containing Ag as the principal ingredient thereof can easily be sulfurated so that sulfur (S) is diffused from the ZnS—SiO₂ films to sulfurate the semi-transmissive film or the reflection film when a laser beam is irradiated onto the optical disk to raise the temperature thereof. After the reflection film or the semi-transmissive film is sulfurated, the characteristics such as reflectivity and thermal conductivity of the film may be reduced to degrade the optical disk itself.

A technique of arranging a barrier film between the reflection film or the semi-transmissive film that contain Ag and the adjacent ZnS—SiO₂ dielectric film may be conceivable for the purpose of preventing sulfuration of the reflection film or the semi-transmissive film. As a matter of fact, Patent Publication JP-2002-144736-A (paragraphs 0056, 0057) describes an optical disk having such a barrier film between the reflection film or semi-transmissive film and the dielectric film.

According to JP-2002-144736-A, the barrier film arranged between the reflection film or the semi-transmissive film and the ZnS—SiO₂ dielectric film can suppress movement of substances between those films if the barrier films are made of SiC, SiN or GeN. However, the provision of the barrier film causes a new problem in that the barrier film renders the optical disk manufacturing process much more complex, and thus raises the cost of manufacturing the optical disk.

The barrier film also raises the problem in a two-recording-film optical disk having a higher recording capacity. The two-recording-film optical disk includes two layer structures each including the recording film and an optical separation film between those layer structures. More specifically, the two-recording-film optical disk includes a first layer structure on the light incident side of the optical disk and a second layer structure behind the first layer structure. The first layer structure includes a first dielectric film, recording film, a second dielectric film and a semi-transmissive film, which are consecutively deposited as viewed from the transparent substrate, whereas the second layer structure includes a first dielectric film, a recording film, a second dielectric film and a reflection film, which are consecutively deposited from the light incident side.

The interface between the semi-transmissive film and the optical separation film is provided with a transmission-factor adjusting film for improving the optical recording/reproducing property of the second layer structure. The transmission-factor adjusting film includes an Ag alloy for achieving the semi-transmissive property, and thus is liable to the sulfuration of Ag.

### SUMMARY OF THE INVENTION

In view of the above-described circumstances, it is therefore an object of the present invention to provide an optical information recording medium including a reflection film, a semi-transmissive film or a transmission-factor adjusting film that contains Ag, which is capable of suppressing sulfuration of the reflection film, the semi-transmissive film or the transmission-adjusting film.

The present invention provides, in a first aspect thereof, an optical information recording medium for recording/reproducing information therein by irradiating a laser beam onto a recording film to change an optical characteristic thereof, the optical disk including: a transparent substrate; a dielectric film overlying the transparent substrate, the dielectric film including oxide of at least one element selected from a first group consisting of niobium and zinc as a principal ingredient thereof, and oxide of at least one element selected from a second group consisting of aluminum, tantalum, silicon, cerium and hafnium, wherein the dielectric film has a content ratio of the oxide of at least one element selected from the second group between 10 molar percents and 45 molar percents.

In accordance with the optical information recording medium of the first aspect of the present invention, the dielectric film has a refractive index higher than the refractive index of the ZnS—SiO2 film to achieve a higher recording efficiency. In addition, the dielectric film dos not include sulfur as the main ingredient thereof, sulfuration of other films including Ag will not occur.

The present invention provides, in a first aspect thereof, an optical information recording medium for recording/reproducing information therein by irradiating a laser beam onto a recording film to change an optical characteristic thereof the optical disk including: a transparent substrate having a main surface and a bottom surface onto which a laser beam is incident; a first dielectric film, a recording film, a second dielectric film, a semi-transmissive film including Ag, a third dielectric film and a fourth dielectric film, which are consecutively formed on the main surface of the transparent substrate, wherein the third dielectric film has a refractive index of n1, which is lower than a refractive index n2 of the fourth dielectric film, and the following relationship holds:
n1−n1≧0.4.

In accordance with the optical information recording medium of the first aspect of the present invention, the relationship between the refractive index n1 and the refractive index n2 increases the transmission factor of the layer structure of the optical disk to achieve an efficient recording/reproducing operation.

### BRIEF DESCRIPTION OF THE DRAWINGS

FIG. 1 is a schematic sectional view of an optical disk according to a first embodiment of the present invention, showing the basic layer structure thereof;

FIG. 2 is a schematic sectional view of an optical disk according to a second embodiment of the present invention, showing the basic layer structure thereof;

FIG. 3 is a schematic sectional view of an optical disk according to a modification of the second embodiment of the present invention, showing the basic layer structure thereof; and

FIG. 4 is a schematic sectional view of an optical disk according to a third embodiment of the present invention, showing the basic layer structure thereof.

### DETAILED DESCRIPTION OF THE PREFERRED EMBODIMENTS

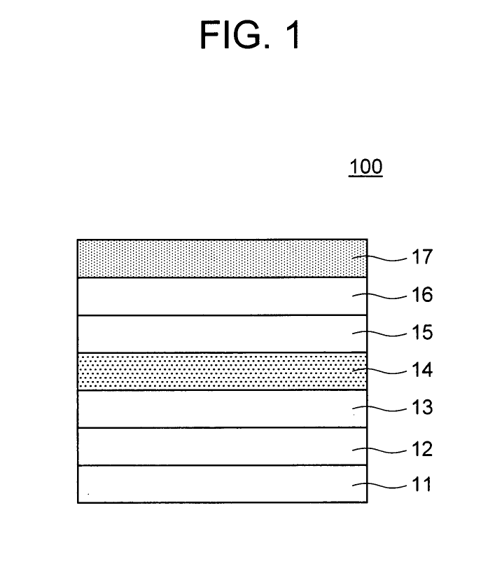

Now, embodiments of the present invention will be described in more detail by referring to the accompanying drawings, wherein similar constituent elements are designated by similar reference numerals. FIG. 1 is a schematic sectional view of an optical disk according to of a first embodiment of the present invention, showing the basic layer structure thereof. Referring to FIG. 1, the optical disk 100 is a rewritable phase-change optical disk such as a DVD (Digital Versatile Disk). The optical disk 100 includes a first dielectric film 12, a first interface film 13, a recording film 14, a second interface film 15, a second dielectric film 16 and a reflection film 17, which are consecutively layered on a transparent substrate 11.

The recording film 14 has a thickness of 13 nm and is typically made of a known recording material such as GeSbTe or AgInSbTe. The reflection film 17 is made of an alloy containing Ag as the principal ingredient thereof, which is selected from the viewpoint of compatibility of a high thermal conductivity and a high transmission factor of light. One or more than one element selected from Pd, Cu, Ge, In, Nd and so on, may be added to the reflection film 17 for the purpose of improving the weather resistance.

The first dielectric film 12 is made of ZnS—SiO₂ that may be expressed by composition formula (ZnS)ₓSiO₂)₁₋ₓ, where 0.5≦x≦0.9. Due to the composition, it is possible to achieve a refractive index as high as 2.3 and a higher deposition rate for the first dielectric film. The interface films 13, 15 are typically made of GeN, SiC or SiN and arranged for the purpose of improving the crystallization rate and the repeatable number of times for recording and reproduction of information.

II place of ZnS—SiO₂ that has been used heretofore in the conventional optical disk, the second dielectric film 16 is made of a material containing oxide of at least one element selected from a first group of elements including niobium and zinc as the principal ingredient and oxide of at least one element selected from a second group of elements including aluminum, tantalum, silicon, cerium and hafnium. For the second dielectric film 16, the composition ratio of the oxide of the element selected from the second group is defined to be not less than 10 mol % and not more than 45 mol %.

The second dielectric film 16 exhibits a refractive index of 2.4 to 2.5, which is higher than that of ZnS—SiO₂. It exhibits a deposition rate substantially same as that of ZnS—SiO₂. In the present embodiment, no barrier film is arranged between the second dielectric film 16 and the reflection film 17 for the purpose of prevention of sulfuration of the reflection film 17.

With the optical disk 100 of the present embodiment, it is possible to prevent sulfuration of the reflection film 17 because the second dielectric film 16 does not contain sulfur. Additionally, since the second dielectric film 16 exhibits a refractive index higher than the ZnS—SiO₂, the optical disk 100 provides a high degree of optical design choice. Still additionally, since the second dielectric film 16 exhibits a deposition rate that is substantially same as that of ZnS—SiO₂, the optical disk 100 can maintain a high manufacturing efficiency.

Due to the anti-sulfuration effect of the reflection film 17 and the high refractive index of the second dielectric film 16 of the present embodiment, it is now possible to remarkably raise the repeatable number of times for recording and reproduction of information as compared to the conventional optical disk that uses ZnS—SiO₂ for the second dielectric film 16. Note that it is not possible to realize a satisfactory repeatable number of times for recording and reproduction of information if the composition ratio of the oxide of the element selected from the second group is less than 10 mol % or more than 45 mol %.

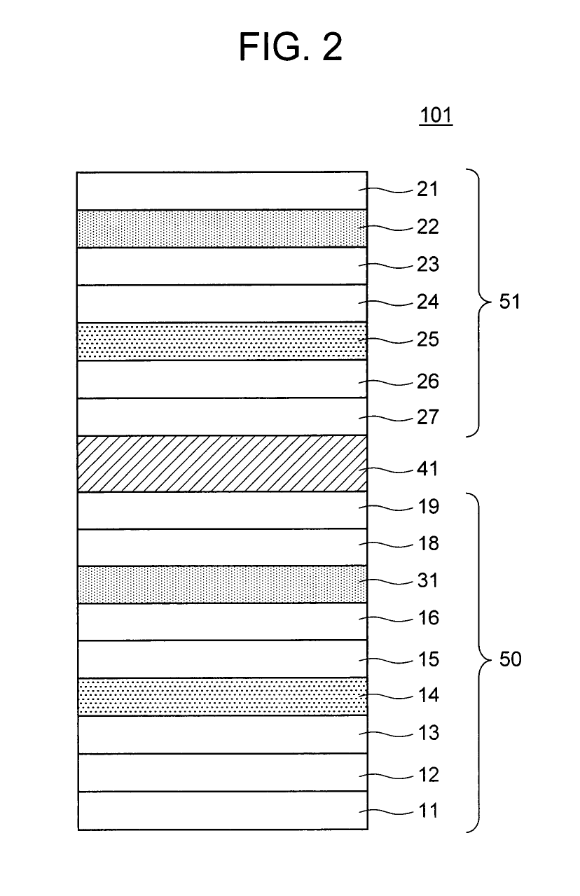

FIG. 2 is a schematic sectional view of an optical disk, which is referred to as optical disk of Type A hereinafter, according to a second embodiment of the present invention, showing the schematic structure thereof. Optical disk 101 includes a first dielectric film 12, a first interface film 13, a recording film 14, a second interface film 15, a second dielectric film 16, a semi-transmissive film 31, a third dielectric film 18 and a fourth dielectric film 19, which are consecutively deposited on a transparent substrate 11. These films are collectively referred to as a first layer structure 50. An optical separation film 41 is formed on the first layer structure 50 and a second layer structure 51 is arranged on the optical separation film 41.

In the second layer structure 51, a reflection film 22, a fifth dielectric film 23, a third interface film 24, a recording film 25, a fourth interface film 26 and a sixth dielectric film 27 are consecutively deposited on another transparent substrate 21. With this optical disk 101, a laser beam to be used for recording/reproducing information is incident onto the first layer structure 50. When manufacturing the optical disk 101, the first layer structure 50 and the second layer structure 51 are formed on respective transparent substrates 11 and 21, and subsequently, the two layer structures 50 and 51 are bonded to each other by way of an optical separation film 41 that is made of ultraviolet-curable resin.

The recording film 14 has a film thickness of 7 nm and is typically made of a known recording material such as GeSbTe or AgInSbTe. The semi-transmissive film 31 is made of an alloy containing Ag as the principal ingredient thereof, which is selected from the viewpoint of compatibility of a high thermal conductivity and a high transmission factor of light. The semi-transmissive film 31 is typically made to have a film thickness of 10 nm. It is possible to render the light transmission factor of the first layer structure 50 to be about 40% to 50% as a result of the combination of the third dielectric film 18 and the fourth dielectric film 19.

To date, metal semi-transmissive films that are translucent with respect to light in a wavelength range of about 405 nm are not known except Ag-alloy thin films. Therefore, Ag-alloy thin films are one of the materials indispensable for semi-transmissive films of optical disks having a plurality of layer structures. One or more than one element selected from Pd, Cu, Ge, In, Nd and so on may appropriately be added to the semi-transmissive film 31 for the purpose of improving the weather resistance.

The first dielectric film 12 is made of ZnS—SiO₂ that is expressed by composition formula (ZnS)ₓ(SiO₂)₁₋ₓ, where 0.5≦x≦0.9. Due to the configuration, it is possible to achieve a high refractive index and a high film deposition rate. The interface films 13, 15 are typically made of GeN, SiC or SiN and arranged for the purpose of improving the crystallization rate and the repeatable number of times for recording and reproduction of information.

As in the first embodiment, in place of ZnS—SiO₂ that has been used heretofore in the conventional optical disk, the second dielectric film 16 in the present embodiment is made of a material containing oxide of at least one element selected from the first group including niobium and zinc as the principal ingredient and oxide of at least one element selected from the second group including aluminums tantalum, silicon, cerium and hafnium. For the second dielectric film 16, the composition ratio of the oxide of the element selected from the second group is defined to be not less than 10 mol % and not more than 45 mol %. In the present embodiment, no barrier film is arranged between the second dielectric film 16 and the reflection film 17 for the purpose of prevention of sulfuration of the reflection film 17.

The third dielectric film 18 and the fourth dielectric film 19 are provided for the purpose of improving the transmission factor of light of the first layer structure 50. The third dielectric film 18 is made of oxide of at least one element selected from the group consisting of silicon, aluminum and hafnium, whereas the fourth dielectric film 19 is made of zinc sulfide and an oxide of silicon. Alternatively, the fourth dielectric film 19 may be made of a material same as the above-described second dielectric film 16 or oxide of Ti or Nb or a mixture of such oxides.

As for the combination of materials of the third dielectric film 18 and the fourth dielectric film 19, the material of the third dielectric film 18 exhibits refractive index n₁ which is lower than the refractive index n₂ of the fourth dielectric film 19, and the difference n₂−n₁ therebetween is not smaller than 0.4. With this arrangement, it is possible to satisfactorily raise the light transmission factor of the first layer structure 50.

Meanwhile, in the conventional optical disks, the third dielectric film 18 is used as a barrier film that is made of a material selected from GeN, SiC, SiN and so on for the purpose of prevention of diffusion of sulfur contained in the fourth dielectric film 19 toward the semi-transmissive film 31. However, if SiC, SN, GeN, AlN, TiN or TaN is used for the third dielectric film 18, it is hardly possible to obtain the first layer structure 50 having a high transmission factor of light even if the design is modified in various different ways, because the difference in the refractive index is small between the fourth dielectric film 19 and the third dielectric film 18.

With regard to the above problem, the inventor of the present invention found that sulfur can hardly diffuse from the third dielectric film 18 that is arranged at the side opposite to the recording film 14 with respect to the semi-transmissive film 31. On the basis of this finding, the difference n₂−n₁ in the refractive index is made sufficiently large between the third dielectric film 18 and the fourth dielectric film 19, by using a dielectric film made of oxide of at least one element selected from the group consisting of silicon, aluminum and hafnium for the third dielectric film 18. As a result, it is possible to effectively improve the transmission factor of light of the first layer structure 50.

Thus, in the optical disk 101 of the present embodiment, since the second dielectric film 16 of the first layer structure 50 does not contain sulfur as in the case of the first embodiment, it is possible to prevent the reflection film 17 from being sulfurated. As a result, it is possible to remarkably improve the repeatable number of times for recording and reproduction of information as compared with the conventional optical disks where ZnS—SiO₂ is used for the second dielectric film. Additionally, since the second dielectric film 16 exhibits a refractive index higher than ZnS—SiO₂, it is possible to raise the degree of optical design choice. Still additionally, since the second dielectric film 16 exhibits a deposition rate substantially same as ZnS—SiO₂, it is possible to maintain a high manufacturing efficiency.

In place of the barrier film used in the conventional optical disk, a dielectric film made of oxide of at least one element selected from the group consisting of silicon, aluminum and hafnium is used for the third dielectric film 18 so that the difference n₂−n₁ in the refractive index between the third dielectric film 18 and the fourth dielectric film 19 is made sufficiently large to effectively improve the transmission factor of light of the first layer structure 50. As a result, it is possible to satisfactorily record information on and reproduce information from the second layer structure 51.

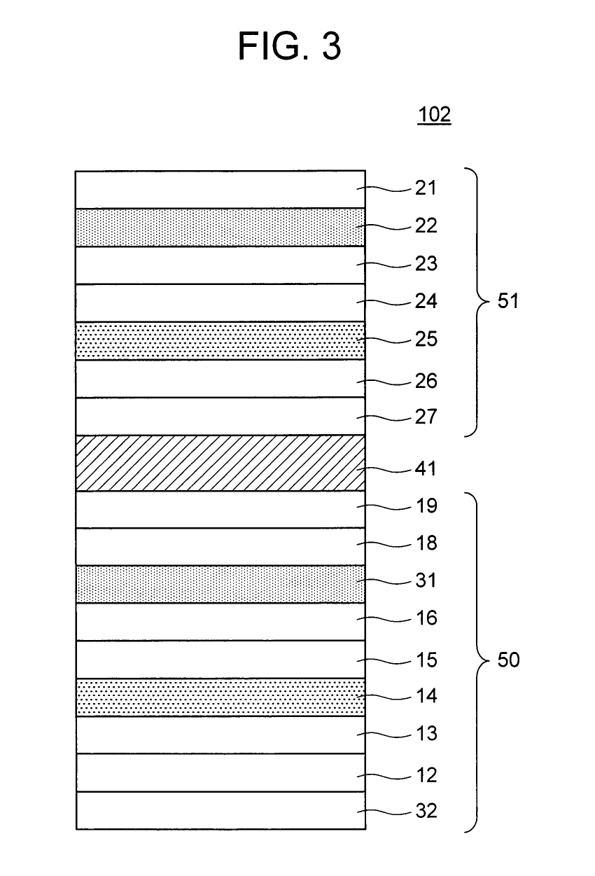

FIG. 3 is a schematic sectional view of an optical disk according to a modification of the second embodiment, which is referred to as optical disk of Type B hereinafter, showing the schematic layer structure thereof. Referring to FIG. 3, a transparent sheet 32 that is made of ultraviolet-set resin is arranged in the optical disk 102 to replace the transparent substrate 11 of the optical disk 101 in FIG. 2. In the optical disk 102, a laser beam to be used for recording/reproducing information is incident onto the first layer structure 50 similarly to the optical disk 101 of Type A.

For manufacturing the optical disk 102, firstly a reflection film 22, a fifth dielectric film 23, a third interface film 24, a recording film 25, a fourth interface film 26, and a sixth dielectric film 27 are consecutively deposited on a transparent substrate 21 to form a second layer structure 51 and subsequently an optical separation film 41 that is made of ultraviolet-set resin is formed on the sixth dielectric film 27. Then, guide grooves (not shown) including lands and grooves are formed on the optical separation film 41.

Thereafter, a fourth dielectric film 19, a third dielectric film 18, a semi-transmissive film 31, a second dielectric film 16, a second interface film 15, a recording film 14, a first interface film 13 and a first dielectric film 12 are consecutively deposited on the optical separation film 41 and subsequently an about 100-μm-thick thin transparent sheet 32 that is made of ultraviolet-curable resin is formed on the first dielectric film 12.

While the optical disk 102 of this modification is different from the optical disk 101 of FIG. 2 in terms of manufacturing process, the layer structure thereof is similar to that of the optical disk 101 of FIG. 2, as viewed from the laser-beam incident side of the optical disk. Therefore, the optical disk 102 of the modification provides advantages similar to those of the above-described optical disk 101.

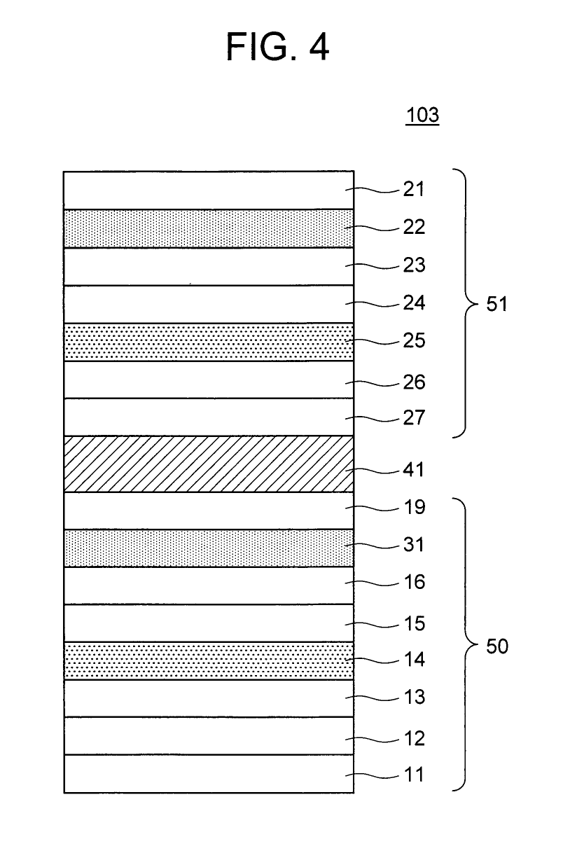

FIG. 4 is a schematic sectional view of an optical disk according to a third embodiment of the present invention, showing the schematic structure thereof. Referring to FIG. 4, the optical disk 103 25 includes a first dielectric film 12, a first interface film 13, a recording film 14, a second interface film 15, a second dielectric film 16, a semi-transmissive film 31 and a fourth dielectric film 19, which are consecutively deposited on a transparent substrate 11 to form a first layer structure 50. Unlike the optical disk 101 of the second embodiment shown in FIG. 2, no third dielectric film 18 is arranged in the present embodiment, and the fourth dielectric film 19 is directly formed on the semi-transmissive film 31. An optical separation film 41 is formed on the first layer structure 50 and a second layer structure 51 is arranged on the optical separation film 41.

The second layer structure 51 has a configuration similar to that of the second layer structure 51 of the optical disk 101 of the second embodiment shown in FIG. 2. When manufacturing the optical disk 103, the first layer structure 50 and the second layer structure 51 are formed on different transparent substrates and then bonded together by way of the optical separation film 41 that is made of ultraviolet-curable resin.

The recording film 14 is typically made of a known recording material such as GeSbTe. The semi-transmissive film 31 is made of an alloy containing Ag the as principal ingredient, which is selected from the viewpoint of compatibility of a high thermal conductivity and a high transmission factor of light. The semi-transmissive film 31 is typically made to have a film thickness of 8 nm. One or more than one element selected from Pd, Cu, Ge, In, Nd and so on may appropriately be added to the semi-transmissive film 31 for the purpose of improving the weather resistance.

The first dielectric film 12 is made of ZnS—SiO₂ that is expressed by composition formula (ZnS)ₓ(SiO₂)₁₋ₓ, where 0.5≦x≦0.9. Due to this configuration, it is possible to achieve a high refractive index and a high film deposition rate. The interface films 13, 15 are typically made of GeN, SiC or SiN and arranged for the purpose of improving the crystallization rate and the repeatable number of times for recording and reproduction of information.

As in the case of the second embodiment, in place of ZnS—SiO₂ that has been used heretofore, the second dielectric film 16 is made of a material containing oxide of at least one element selected from the first group including niobium and zinc as the principal ingredient and oxide of at least one element selected from the second group including aluminum, tantalum, silicon, cerium and hafnium. For the second dielectric film 16, the composition ratio of the oxide of the element selected from the second group is defined to be not less than 10 mol % and not more than 45 mol %.

The fourth dielectric film 19 is provided for the purpose of improving the transmission factor of light of the first layer structure 50. A material having a refractive index higher than that of the fourth dielectric film 19 of the second embodiment is used for the fourth dielectric film 19 of the present embodiment for the purpose of satisfactorily raising the optical interference effect between the fourth dielectric film 19 and the semi-transmissive film 31. Preferably, a material similar to that of the above-described second dielectric film 16 or oxide of Ti or Nb or a mixture of such oxides is used for the fourth dielectric film 19.

Although the optical disk of the present embodiment is not provided with any third dielectric film 18 unlike the second embodiment, it is possible to set the transmission factor of light of the first layer structure 50 to about 40% to 50% by reducing the thickness of the recording film 14 and that of the semi-transmissive film 31 with respect to those of the second embodiment and raising the refractive index of the fourth dielectric film 19. The value of the transmission factor of light is that (Tc) of the recording film 14 in a crystalline state or that (Ta) of the recording film 14 in an amorphous state.

In the optical disk 101 of the second embodiment shown in FIG. 2, the thickness of the recording film 14 and that of the semi-transmissive film 31 can be reduced further depending on the composition of the recording film 14. Then, since the transmission factor of light of the recording film 14 and that of the semi-transmissive film 31 are raised so that it is possible to satisfactorily raise the transmission factor of light of the first layer structure 50 simply by eliminating the third dielectric film 18 shown in FIG. 2 and improving the optical interference effect between the semi-transmissive film 31 and the fourth dielectric film 19. Then, the number of films is reduced so that it is possible to reduce the manufacturing cost.

Therefore, in the present embodiment, it is possible to reduce the thickness of the recording film 14 and that of the semi-transmissive film 31 and at the same time arranging the fourth dielectric film 19 having a higher refractive index directly on the semi-transmissive film 31 in order to satisfactorily improve the transmission factor of light of the first layer structure 50 and reduce the manufacturing cost.

### EXAMPLE 1

In this example, optical disks were prepared on the basis of the first embodiment as optical disks of Example 1. A polycarbonate substrate was used as the transparent substrate 11 in the optical disks of Example 1. The first dielectric film 12 was made of ZnS—SiO₂ to have a film thickness of 50 nm and the recording film 14 was made of GeSbTe to have a film thickness of 12 nm whereas the first interface film 13 and the second interface film 15 were made of GeN film and the reflection film 17 was made of AgPdCu film. A variety of film compositions were used for the second dielectric film 16 to produce optical disks having a second dielectric film 16 of a variety of film compositions.

For the purpose of comparison, an optical disk having a second dielectric film 16 that is made of ZnS—SiO₂ was prepared as the optical disk of Comparative Example 1. Also for the purpose of comparison, an optical disk having a reflection film 17 directly formed on the transparent substrate 11 and a ZnS—SiO₂ dielectric film directly formed on the reflection film 17 was prepared as the optical disk of Comparative Example 2.

After preparing the optical disks of Example 1 and Comparative Examples 1 and 2, the optical disks of Example 1 and Comparative Example 1 were initialized and the relationship of the film composition of the second dielectric film 16, presence or absence of sulfuration in the reflection film 17 after an environment test, the repeatable number of times for recording and reproduction of information and the smallest laser beam power required for recording (recording power) was examined. Presence or absence of sulfuration in the reflection film 17 of the optical disk of Comparative Example 2 was checked after an environment test.

As for the conditions of the environment test, the sample optical disks were left for 500 hours in an environment where the ambient temperature is 85° C. and the relative humidity is 90%. Since a region where corrosion takes place due to sulfuration exhibits a color different from other ordinary regions, it is possible to discriminate such a region visually or by observation through a microscope. As for the repeatable number of times for recording and reproduction of information, a recording mark having a length of 1 μm was repeatedly overwritten at a linear velocity of 6.6 m/sec to see the number of times of overwriting until C/N falls by 3 dB. The wavelength of the laser beam was within a range between 380 nm and 430 nm.

Tables 1 through 3 show the relationship of the film composition of the second dielectric film 16, presence or absence of sulfuration in the reflection film 17, the repeatable number of times for recording and reproduction of information and the recording power when two elements were selected from the second group, whereas Table 4 shows the same relationship when two elements were selected from the first group. Table 1 shows some of the results obtained when Nb₂O₅, Al₂O₃ and Ta₂O₅ were used for the second dielectric film 16. In Table 1, X, Y and Z respectively represent the molar content ratio of Nb₂O₅, Al₂O₃ and Ta₂O₅. For the optical disk of Comparative Example 2, only the result of checking presence or absence of sulfuration is shown.

TABLE 1

| | | | | | Repeatable | |
|---|---|---|---|---|---|---|
| | X | Y | Z | Presence or | number of | Recording |
| | (mol | (mol | (mol | absence of | times of | power |
| No. | %) | %) | %) | sulfuration | OW | (mW) |
| 1 | 95 | 2.5 | 2.5 | Absent | 500 | 8.2 |
| 2 | 90 | 5 | 5 | Absent | 1500 | 7.3 |
| 3 | 85 | 7.5 | 7.5 | Absent | 2000 | 6.5 |
| 4 | 80 | 10 | 10 | Absent | 3000 | 6.1 |
| 5 | 75 | 12.5 | 12.5 | Absent | 3000 | 5.7 |
| 6 | 70 | 15 | 15 | Absent | 3000 | 5.5 |
| 7 | 65 | 15 | 20 | Absent | 3000 | 5.6 |
| 8 | 60 | 15 | 25 | Absent | 3000 | 5.5 |
| 9 | 55 | 20 | 25 | Absent | 3000 | 5.4 |
| 10 | 50 | 30 | 20 | Absent | 800 | 5.5 |
| 11 | 45 | 25 | 30 | Absent | 700 | 5.5 |

| | | | | |
|---|---|---|---|---|
| 12 | ZnS—SiO₂ | Present | 500 | 5.7 |
| 13 | PC/AgPdCu/ZnS—SiO₂ | Absent | Not | Not |
| | | | objected | objected |

Table 2 shows some of the results obtained when Nb₂O₅, Al₂O₃ and SiO₂ were used for the second dielectric film 16. In Table 2, X, Y and Z respectively represent the mol content ratios of Nb₂O₅, Al₂O₃ and SiO₂.

TABLE 2

| | | | | | Repeatable | |
|---|---|---|---|---|---|---|
| | X | Y | Z | Presence or | number of | Recording |
| | (mol | (mol | (mol | absence of | times of | power |
| No. | %) | %) | %) | sulfuration | OW | (mW) |
| 1 | 95 | 1 | 4 | Absent | 300 | 8.0 |
| 2 | 90 | 3 | 7 | Absent | 1200 | 7.2 |
| 3 | 85 | 5 | 10 | Absent | 1900 | 6.6 |
| 4 | 80 | 10 | 10 | Absent | 2700 | 6.2 |
| 5 | 75 | 12.5 | 12.5 | Absent | 3000 | 5.5 |
| 6 | 70 | 15 | 15 | Absent | 3000 | 5.7 |
| 7 | 65 | 17 | 18 | Absent | 3000 | 5.6 |
| 8 | 60 | 15 | 25 | Absent | 2800 | 5.5 |
| 9 | 55 | 5 | 40 | Absent | 3000 | 5.3 |
| 10 | 50 | 25 | 25 | Absent | 600 | 5.4 |
| 11 | 45 | 25 | 30 | Absent | 400 | 5.5 |

Table 3 shows some of the results obtained when Nb₂O₅, Ta₂O₅ and SiO₂ were used for the second dielectric film 16. In Table 3, X, Y and Z respectively represent the mol content ratio of Nb₂O₅, Ta₂O₅ and SiO₂.

TABLE 3

| | | | | | Repeatable | |
|---|---|---|---|---|---|---|
| | X | Y | Z | Presence or | number of | Recording |
| | (mol | (mol | (mol | absence of | times of | power |
| No. | %) | %) | %) | sulfuration | OW | (mW) |
| 1 | 95 | 4 | 1 | Absent | 600 | 8.4 |
| 2 | 90 | 7 | 3 | Absent | 1500 | 7.1 |
| 3 | 85 | 10 | 5 | Absent | 2200 | 6.3 |
| 4 | 80 | 10 | 10 | Absent | 2600 | 6.2 |
| 5 | 75 | 20 | 5 | Absent | 3000 | 5.6 |
| 6 | 70 | 10 | 20 | Absent | 2900 | 5.7 |
| 7 | 65 | 20 | 15 | Absent | 3000 | 5.4 |
| 8 | 60 | 20 | 20 | Absent | 2900 | 5.5 |
| 9 | 55 | 30 | 15 | Absent | 3000 | 5.5 |
| 10 | 50 | 20 | 30 | Absent | 800 | 5.6 |
| 11 | 45 | 20 | 35 | Absent | 570 | 5.7 |

Table 4 shows some of the results obtained when Nb₂O₅, ZnO and SiO₂ were used for the second dielectric film 16. In Table 2, X, Y and Z respectively represent the mol content ratio of Nb₂O₅, ZnO and SiO₂.

TABLE 4

| | | | | | Repeatable | |
|---|---|---|---|---|---|---|
| | X | Y | Z | Presence or | number of | Recording |
| | (mol | (mol | (mol | absence of | times of | power |
| No. | %) | %) | %) | sulfuration | OW | (mW) |
| 1 | 7 | 85 | 8 | Absent | 700 | 8.3 |
| 2 | 10 | 80 | 10 | Absent | 2000 | 7.0 |
| 3 | 15 | 75 | 10 | Absent | 2300 | 6.1 |
| 4 | 15 | 70 | 15 | Absent | 2500 | 5.6 |
| 5 | 17.5 | 65 | 17.5 | Absent | 2500 | 5.7 |
| 6 | 20 | 60 | 20 | Absent | 2900 | 5.8 |
| 7 | 20 | 55 | 25 | Absent | 2800 | 5.8 |
| 8 | 20 | 50 | 30 | Absent | 3000 | 5.6 |
| 9 | 20 | 45 | 35 | Absent | 2500 | 5.4 |
| 10 | 15 | 40 | 45 | Absent | 1800 | 5.4 |
| 11 | 10 | 40 | 50 | Absent | 400 | 5.4 |

By paying attention to the repeatable number of times for recording and reproduction of information in Tables 1 through 3, it was found that the repeatable number of times for recording and reproduction of information exceeded 1,000 times to prove a remarkable improvement when the second dielectric film 16 contains oxide of niobium selected from the first group as the principal ingredient and oxide of an element appropriately selected from the seconnd group and the composition ratio of the oxide of the element selected from the second group is between 10 mol % and 45 mol %. Thus, as a result, the good optical design of the optical disks was proved.

On the other hand, it was found that a satisfactory repeatable number of times for recording and reproduction of information is not achieved when the composition ratio of the oxide of the element selected from the second group is less than 10 mol % or more than 45 mol %. A satisfactory repeatable number of times is not achieved when the composition ratio is less than 10 mol % probably because the thermal conductivity of the second dielectric film 16 is increased to raise the recording power to an excessively high value. A satisfactory repeatable number of times is not achieved when the composition ratio is more than 45 mol % probably because the refractive index of the second dielectric film 16 falls and hence the film thickness of the second dielectric film 16 has to be raised to compensate the fall so that the heat generated in the recording film 14 is poorly transmitted to the reflection film 17 that is thermally highly conductive.

From Table 4, it is seen that results similar to those of Tables 1 through 3 are obtained when the second dielectric film 16 contains oxide of niobium and that of zinc, niobium and zinc being selected from the first group, as the principal ingredients and also oxide of silicon selected from the second group.

Each of Tables 5 and 6 below shows the relationship of the film composition of the second dielectric film 16, presence or absence of sulfuration, the repeatable number of times for recording and reproduction of information (OW) and the recording power when an element was selected from each of Groups A and B. More specifically, Table 5 shows the results obtained when the second dielectric film 16 is made of Nb₂O₅ and Al₂O₃. In Table 5, X and Y respectively represent the mol content ratios of Nb₂O₅ and Al₂O₃.

TABLE 5

| | | | | Repeatable | |
|---|---|---|---|---|---|
| | X | Y | Presence or | number of | Recording |
| | (mol | (mol | absence of | times of | power |
| No. | %) | %) | sulfuration | OW | (mW) |
| 1 | 95 | 5 | Absent | 500 | 8.4 |
| 2 | 93 | 7 | Absent | 650 | 8.3 |
| 3 | 90 | 10 | Absent | 1500 | 7.3 |
| 4 | 87 | 13 | Absent | 1500 | 7.3 |
| 5 | 85 | 15 | Absent | 2000 | 6.5 |
| 6 | 80 | 20 | Absent | 3000 | 6.1 |
| 7 | 70 | 30 | Absent | 3000 | 5.7 |
| 8 | 60 | 40 | Absent | 3000 | 5.5 |
| 9 | 55 | 45 | Absent | 3000 | 5.6 |
| 10 | 50 | 50 | Absent | 950 | 5.5 |
| 11 | 45 | 55 | Absent | 860 | 5.4 |
| 12 | 40 | 60 | Absent | 800 | 5.5 |

Table 6 shows the results obtained when the second dielectric film 16 is made of Nb₂O₅ and Ta₂O₅. In Table 5, X and Y respectively represent the mol content ratios of Nb₂O₅ and Ta₂O₅.

TABLE 6

| | | | | Repeatable | |
|---|---|---|---|---|---|
| | X | Y | Presence or | number of | Recording |
| | (mol | (mol | absence of | times of | power |
| No. | %) | %) | sulfuration | OW | (mW) |
| 1 | 95 | 5 | Absent | 530 | 8.5 |
| 2 | 93 | 7 | Absent | 620 | 8.4 |
| 3 | 90 | 10 | Absent | 1400 | 7.3 |
| 4 | 87 | 13 | Absent | 1600 | 7.2 |
| 5 | 85 | 15 | Absent | 2100 | 6.4 |
| 6 | 80 | 20 | Absent | 3000 | 6.2 |
| 7 | 70 | 30 | Absent | 3000 | 5.8 |
| 8 | 60 | 40 | Absent | 3000 | 5.3 |
| 9 | 55 | 45 | Absent | 3000 | 5.2 |
| 10 | 50 | 50 | Absent | 900 | 5.1 |
| 11 | 45 | 55 | Absent | 830 | 5.1 |
| 12 | 40 | 60 | Absent | 780 | 5.1 |

From Tables 5 and 6, it is seen that the repeatable number of times for recording and reproduction of information exceeded 1,000 times to prove a remarkable improvement when the second dielectric film 16 contains oxide of an element selected from the first group and also oxide of an element selected from the second group and the composition ratio of the oxide of the element selected from the second group is between 10 mol % and 45 mol % as in the case of Tables 1 through 4.

It was found that similar effects can be achieved when a protection film material containing oxide of an element selected from the first group and oxide of an element selected from the second group except aluminum and tantalum is used for the second dielectric film 16. Furthermore, similar effects can be achieved when the second dielectric film 16 made of a material containing oxide of at least one element selected from the first group including niobium and zinc, the oxide being other than the oxides listed in Tables 1 through 6, as principal ingredient and oxide of an element selected from the second group including hafnium.

By paying attention to presence or absence of sulfuration in Tables 1 through 6, it was found that corrosion due to sulfuration was observed when the second dielectric film 16 was made of ZnS—SiO₂ that contains sulfur but no corrosion due to sulfuration was observed when the second dielectric film 16 contained no sulfur.

Meanwhile, while the reflection film 17 is arranged adjacent to a ZnS—SiO₂ dielectric film in the optical disk of Comparative Example 2, no corrosion due to sulfuration was observed in the optical disk. From this observation, it was found that sulfuration readily appears in the reflection film 17 when a ZnS—SiO₂ dielectric film is arranged between the recording film 14 and the reflection film 17, and sulfuration hardly appears in the reflection film 17 when a ZnS—SiO₂ dielectric film is arranged at the opposite side of the recording film 14 as viewed from the reflection film 17. It may be correct to assume that this phenomenon arises because the potential difference between the recording film 14 and the reflection film 17 has an influence on the diffusion of sulfur.

### EXAMPLE 2

Optical disks of Example 2 were prepared by forming the first layer structure 50 according to the second embodiment and subsequently bonding the same with a dummy substrate for each optical disk. A polycarbonate substrate was used for the transparent substrate 11 of the optical disks of Example 2. The first dielectric film 12 was made of ZnS—SiO₂ to have a film thickness of 50 nm and the recording film 14 was made of GeSbTe to have a film thickness of 7 nm, whereas the first interface film 13 and the second interface film 15 were made of GeN to have a film thickness of 3 nm and the semi-transmissive film 31 was made of AgPdCu to have a film thickness of 10 nm.

A film formed in Example 1 and containing Nb₂O₅ at 60 mol %, Al₂O₃ at 15 mol % and Ta₂O₅ at 25 mol % was selected for the second dielectric film 16, which was made to have a film thickness of 15 nm.

The fourth dielectric film 19 was made of ZnS—SiO₂ to a film thickness of 110 nm. A Variety of film compositions were used for the third dielectric film 18 to produce optical disks having a third dielectric film 18 of a variety of film compositions.

After preparing the optical disks of Example 2, the relationship of the difference n₂−n₁ in the refractive index between the third dielectric film 18 and the fourth dielectric film 19, the transmission factor of light of the first layer structure 50, the number of designable candidates and presence or absence of sulfuration after an environment test was examined. As for the transmission factor of light of the first layer structure 50, the sum of the transmission factor of light Ta of the recording film 14 in an amorphous state and the transmission factor of light Tc of the recording film 14 in a crystalline state was checked from the design viewpoint. As for the number of designable candidates, the designable number was checked under a condition that the reflectivity is not less than 4% for the recording film 14 in a crystalline state and not higher than 2% in an amorphous state by changing the parameters such as the thicknesses of the films. The wavelength of the laser beam was within a range between 380 nm and 430 nm. The environment test was conducted under the conditions same as Example 1. Table 7 below shows some of the obtained results.

TABLE 7

| Third | Refractive | | | Presence or |
|---|---|---|---|---|
| dielectric | index | Transmittance | Number of | absence of |
| film 18 | difference | factor (%) | candidates | sulfuration |
| ZnS—SiO₂ | 0 | 93.4 | 3 | Absent |
| GeN | 0.2 | 97.0 | 7 | Absent |
| SiN | 0.25 | 97.3 | 9 | Absent |
| Al₂O₃ | 0.4 | 98.5 | 15 | Absent |
| Al₂O₃—HfO₂ | 0.45 | 98.7 | 17 | Absent |
| HfO₂ | 0.5 | 99.0 | 18 | Absent |
| Al₂O₃—SiO₂ | 0.55 | 99.3 | 20 | Absent |
| HfO₂—SiO₂ | 0.6 | 100.4 | 20 | Absent |
| SiO₂ | 0.7 | 101.7 | 23 | Absent |

### EXAMPLE 3

Optical disks of Example 3 were prepared by forming optical disks similar to those of Example 2 except for using a 15 nm-thick film containing Nb₂O₅ at 70 mol % and Al₂O₃ at 30 mol % for the second dielectric film 16 prepared in Example 1. The relationship of items same as those of Table 7 was examined. Table 8 below shows some of the obtained results.

TABLE 8

| Third | Refractive | | | Presence or |
|---|---|---|---|---|
| dielectric | index | Transmittance | Number of | absence of |
| film 18 | difference | factor (%) | candidates | sulfuration |
| ZnS—SiO₂ | 0 | 93.2 | 2 | Absent |
| GeN | 0.2 | 96.8 | 6 | Absent |
| SiN | 0.25 | 97.1 | 9 | Absent |
| Al₂O₃ | 0.4 | 98.2 | 14 | Absent |
| Al₂O₃—HfO₂ | 0.45 | 98.6 | 18 | Absent |
| HfO₂ | 0.5 | 99.0 | 18 | Absent |
| Al₂O₃—SiO₂ | 0.55 | 99.2 | 19 | Absent |
| HfO₂—SiO₂ | 0.6 | 100.2 | 20 | Absent |
| SiO₂ | 0.7 | 101.4 | 22 | Absent |

By paying attention to the refractive index difference, the transmission factor of light and the number of candidates in Tables 7 and 8, it was found that the transmission factor of light rises and the number of candidates increases as the refractive index difference increases. In other words, it is possible to stably record information on and reproduce information from the second layer structure 51 and obtain an optical disk with a large design margin when the refractive index difference is large.

A high transmission factor of light and a large number of candidates were obtained when the refractive index difference is not less than 0.4. The refractive index difference is not less than 0.4 when Al₂O₃, Al₂O₃—HfO₂, HfO₂, Al₂O₃—SiO₂, HfO₂—SiO₂ or SiO₂ is used for the third dielectric film 18. Conversely, a particularly low transmission factor of light is obtained when ZnS—SiO₂ is used for the third dielectric film 18. It should be noted that the transmission factor of light T(Ta+Tc) of the first layer structure 50 is generally required to be not less than 85% as thumbnail and a higher value is advantageous.

By paying attention to presence or absence of sulfuration in Tables 7 and 8, no corrosion due to sulfuration was observed in any of the optical disks including those having a third dielectric film 18 made of ZnS—SiO₂. It may be correct to assume that the reason described above for Example 1 also applies here. However, although it is not necessary to provide a third dielectric film 18 that operates as the barrier film, it is preferable that the refractive index of the third dielectric film 18 is lower than that of the fourth dielectric film 19 and the refractive index difference n₂−n₁ is not less than 0.4, from the viewpoint of increasing the transmission factor of light of the first layer structure 50.

The above-described dielectric film that is used for the second dielectric film 16 may be replaced by any of the dielectric films described above for the second embodiment to provide the same advantages. The above-described dielectric film of the fourth dielectric film 19 that is made of zinc sulfide and silicon oxide may be replaced by the second dielectric film 16 of the second embodiment or a dielectric film made of oxide of Ti or Nb or a mixture of the oxides to give rise to similar advantages.

### EXAMPLE 4

Optical disks were prepared by forming the first layer structure 50 according to the third embodiment and bonding the same onto a dummy substrate for each optical disks of Example 4. A polycarbonate substrate was used for the transparent substrate 11 in the optical disks of Example 4. The first dielectric film 12 was made of ZnS—SiO₂ to have a film thickness of 50 nm and the recording film 14 was made of GeSbTe to have a film thickness of 6 nm, whereas the first interface film 13 and the second interface film 15 were made of GeN film to have a film thickness of 3 nm and the semi-transmissive film 31 was made of AgPdCu film to have a film thickness of 8 nm.

The second dielectric film 16 and the fourth dielectric film 19 were formed by using the same protection film material having a film composition same as the one described in Example 1. Optical disks of Example 4 having a second dielectric film 16 and a fourth dielectric film 19 of any of various film compositions were produced. Then, the relationship of the film composition of the second dielectric film 16 and the fourth dielectric film 19, the transmission factor of light of the first layer structure 50, the repeatable number of times of OW and the recording power was examined. Table 9 below shows some of the results obtained when the second dielectric film 16 and the fourth dielectric film 19 were made of Nb₂O₅, Al₂O₃ and Ta₂O₅.

TABLE 9

| | | | | | Repeatable | |
|---|---|---|---|---|---|---|
| | X | Y | Z | | number of | Recording |
| | (mol | (mol | (mol | Transmittance | times of | power |
| No. | %) | %) | %) | factor (%) | OW | (mW) |
| 1 | 95 | 2.5 | 2.5 | 99.0 | 500 | 8.3 |
| 2 | 90 | 5 | 5 | 97.2 | 1300 | 7.5 |
| 3 | 80 | 10 | 10 | 94.4 | 2900 | 6.0 |
| 4 | 70 | 15 | 15 | 91.2 | 3000 | 5.6 |
| 5 | 60 | 15 | 25 | 86.4 | 3000 | 5.4 |
| 6 | 55 | 20 | 25 | 85.6 | 3000 | 5.5 |
| 7 | 50 | 30 | 20 | 81.6 | 700 | 5.3 |

Table 10 below shows some of the results obtained when the second dielectric film 16 and the fourth dielectric film 19 were made of Nb₂O₅ and Al₂O₃.

TABLE 10

| | | | | repeatable | |
|---|---|---|---|---|---|
| | X | Y | | number of | recording |
| | (mol | (mol | Transmittance | times of | power |
| No. | %) | %) | factor (%) | OW | (mW) |
| 1 | 95 | 5 | 97.8 | 500 | 8.3 |
| 2 | 90 | 10 | 96.4 | 1300 | 7.5 |
| 3 | 80 | 20 | 94.6 | 2900 | 6.0 |
| 4 | 70 | 30 | 92.2 | 3000 | 5.6 |
| 5 | 60 | 40 | 87.0 | 3000 | 5.4 |
| 6 | 55 | 45 | 85.1 | 3000 | 5.5 |
| 7 | 50 | 50 | 79.6 | 700 | 5.3 |

Table 11 below shows some of the results obtained when the second dielectric film 16 and the fourth dielectric film 19 were made of Nb₂O₅ and Ta₂O₅.

TABLE 11

| | | | | Repeatable | |
|---|---|---|---|---|---|
| | X | Y | | number of | Recording |
| | (mol | (mol | Transmittance | times of | power |
| No. | %) | %) | factor (%) | OW | (mW) |
| 1 | 95 | 5 | 99.2 | 400 | 8.3 |
| 2 | 90 | 10 | 97.6 | 1200 | 7.5 |
| 3 | 80 | 20 | 95.6 | 2700 | 6.0 |
| 4 | 70 | 30 | 93.0 | 3000 | 5.6 |
| 5 | 60 | 40 | 87.8 | 3000 | 5.4 |
| 6 | 55 | 45 | 85.2 | 3000 | 5.5 |
| 7 | 50 | 50 | 80.2 | 650 | 5.3 |

From Tables 9 through 11, it is seen that the transmission factor of light of the first layer structure 50 is high when the content ratio of the oxides of the elements selected from the second group is low. This is because the refractive index of the dielectric film becomes high as the content ratio of the oxides of the elements selected from the second group falls. Note that the content ratio of the oxides of the elements selected from the second group is preferably found within a range between 10 mol % and 45 mol % as pointed out in Example 1 from the viewpoint of offset of the repeatable number of times of OW and the recording power.

As modifications to the optical disks of Example 4, optical disks in which the second dielectric film 16 was made of a conventional ZnS—SiO₂ film and a barrier film of GeCrN or SiN was interposed between the second dielectric film 16 and the semi-transmissive film 31 were prepared. It was found that the effects similar to those of Example 3 were obtained when the fourth dielectric film 19 was made of Nb₂O₅, Al₂O₃ and Ta₂O₅, or Nb₂O₅ and Al₂O₃.

While the present invention is described above in terms of preferred embodiments, an optical information recording medium according to the present invention is by no means limited to the above-described embodiments and optical information recording mediums prepared by modifying and/or altering the above-described embodiments will fall within the scope of the present invention.

What is claimed is:

1. An optical information recording medium for recording/reproducing information therein by irradiating a laser beam onto a recording film to change an optical characteristic thereof, said optical disk comprising:
a transparent substrate;
a dielectric film overlying said transparent substrate, said dielectric film including oxide of at least one element selected from a first group consisting of niobium and zinc as a principal ingredient thereof, and oxide of at least one element selected from a second group consisting of aluminum, tantalum, silicon, cerium and hafnium,
wherein said dielectric film has a content ratio of said oxide of at least one element selected from the second group between 10 molar percents and 45 molar percents.

2. The optical information recording medium according to claim 1, further comprising a reflection layer including silver and disposed behind said recording film as viewed from a laser beam incident side, wherein said dielectric film is disposed between said recording film and said reflection film and adjacent to said reflection film.

3. The optical information recording medium according to claim 1, further comprising a semi-transmissive film including silver and disposed behind said recording film as viewed from a laser beam incident side, wherein said dielectric film is disposed between said recording film and said semi-transmissive film and adjacent to said semi-transmissive film.

4. The optical information recording medium according to claim 1, wherein said laser beam has a wavelength of 380 to 430 nm.

5. An optical information recording medium for recording/reproducing information therein by irradiating a laser beam onto a recording film to change an optical characteristic thereof, said optical disk comprising:
a transparent substrate having a main surface and a bottom surface onto which a laser beam is incident;
a first dielectric film, a recording film, a second dielectric film, a semi-transmissive film including Ag, a third dielectric film and a fourth dielectric film, which are consecutively formed on said main surface of said transparent substrate,
wherein said third dielectric film has a refractive index of n1, which is lower than a refractive index n2 of said fourth dielectric film, and the following relationship holds:
n2−n1≧0.4.

6. The optical information recording medium according to claim 5, wherein said second and fourth dielectric films include oxide of at least one element selected from a first group consisting of niobium and zinc, and oxide of at least one element selected from a second group consisting of aluminum, tantalum, silicon, cerium and hafnium, and wherein said fourth dielectric film has a content ratio of said oxide of at least one element selected from the second group between 10 molar percents and 45 molar percents.

7. The optical information recording medium according to claim 5, wherein said third dielectric film includes as a principal ingredient thereof oxide of at least one element selected from the group consisting of silicon, aluminum and hafnium.

8. The optical information recording medium according to claim 5, wherein said laser beam has a wavelength of 380 to 430 nm.
